(19) United States
(12) Patent Application Publication
(10) Pub. No.: US 2016/0340124 A1
(43) Pub. Date: Nov. 24, 2016

(54) WORM SCREW FOR USE IN AN EXTRUDER AND EXTRUDER

(71) Applicant: Reifenhäuser GmbH & Co. KG Maschinenfabrik, Troisdorf (DE)

(72) Inventors: Helmut MEYER, Troisdorf (DE); Jochen HENNES, Sankt Augustin (DE)

(21) Appl. No.: 15/159,247

(22) Filed: May 19, 2016

(30) Foreign Application Priority Data
May 22, 2015 (DE) 10 2015 006 479.7

(51) Int. Cl. B65G 33/26

(52) U.S. Cl. CPC B65G 33/26; B65G 2812/0527

(57) ABSTRACT

A screw to be used in an extruder, in particular in a single-screw extruder or a multiple screw extruder. The screw includes a spindle and a plurality of segments supported by the spindle and mutually arranged axially with sealed segment boundaries. A separate moment bridge is disposed between a first segment and an axially adjacent second segment. The moment bridge is configured to transfer a moment over the segment boundary from the first segment to the second segment.

### CROSS-REFERENCE TO RELATED APPLICATIONS

This application is related to and claims the benefit of German Patent Application No. DE 10 2015 006 479.7, filed on May 22, 2015, the contents of which are herein incorporated by reference in its entirety.

### TECHNICAL FIELD

The disclosure relates to a worm screw for use in an extruder and to an extruder with such a worm screw.

In particular, the disclosure relates to a worm screw to be used in a twin screw extruder and to a twin screw extruder.

### BACKGROUND

In general, worm screws have a modular structure. Therefore, they can be adapted very flexibly to altered tasks and product characteristics. The modular structure of a worm screw includes a rod-shaped core, called mandrel or spindle, and individual screw elements which are slid onto the spindle. The elements perform the classic functions of the screw during the extrusion process, such as conveying, kneading, mixing or cutting of the plastic material which is fed into and through the extruder.

For transmission of the high torque, the elements are in positive engagement with the spindle and in addition braced axially.

DE 10 2008 028 289 A1 discloses a worm screw which at its end face transfers the torque from segment to segment by means of teeth.

DE 103 30 530 A1 describes a shaft onto which a sleeve is welded. Segments are threaded up to the stopping point. DE 10 2011 112 148 A1, DE 10 2004 042 846 B4 and DE 196 21 571 C2 each disclose special tooth gearings between the screw segments and the spindle.

The disclosure provides an improved or alternative worm screw for use in an extruder or an extruder.

### SUMMARY

In a first aspect of the present disclosure, a worm screw to be used in an extruder is provided, the screw having a spindle and a plurality of segments supported by the spindle and arranged axially with respect to each other, with sealed segment boundaries, a separate moment bridge being provided between each first segment and each axially adjacent second segment of the screw, which moment bridge is designed to transfer one moment from the first to the second segment laterally to the spindle over the segment boundary.

The terms are explained in more detail as follows:

The “segments” are those components of the screw which together form the spiral or the plurality of spirals, respectively, for plasticizing the plastic to be conveyed through the extruder in cooperation with the extruder cylinder.

Every two axially adjacent segments abut axially against each other at their segment boundaries, either directly, in the case of directly adjacent segments, or indirectly, in the case of one or more intermediary segments between them. The slot forming between them, in the simplest case an annulus, must be sealed against the penetration of plastic melt towards the inside, i.e. towards the spindle. For this purpose, the segments are normally braced axially. The negative normal force causes sufficient sealing due to surface pressure.

The “moment bridges” must cooperate both with the first segment and with the second segment. If a moment acts on the screw, at one particular segment, the first segment largely transfers the moment to the moment bridge. The moment bridge then transfers the moment to the axially adjacent second segment.

The moment bridge itself is neither integral with the first nor with the second segment but a separate element of the composite screw.

At the transition point from a first segment to a second segment, the moment bridge can include several components or of only one component.

It is explicitly pointed out, as a general rule, that within the framework of the present patent application, indefinite articles and mathematical terms such as “one”, “two” etc., are to be understood as minimum terms, i. e. as “at least one”, “at least two” etc., unless it is explicitly or implicitly included in the context or obvious to the person skilled in the art that only “exactly one”, “exactly two” etc. is intended.

However, the worm screw according to the disclosure should have a plurality of adjacent segments with a moment bridge. In other words, several segment boundaries between two axially adjacent segments should be bridged by a moment bridge. It is possible for one bridge to transfer the moment from segment to segment for a plurality of segment boundaries to be bridged; however, a preferred embodiment provides for one moment bridge to transfer only the moment of one segment boundary transition.

The moment transfer “laterally to the spindle” means that the moment transfer takes place independently of the spindle, at least for the most part, in particular for at least 90%. In view of the force of gravity with which each segment acts on the spindle anyway, causing friction, preferably the moment transfer is taken off the spindle as far as possible and transferred to the segments and the moment bridges (ββ).

The transfer “laterally to” the spindle means preferably, but not necessarily, that moment transfer takes place radially outside the spindle.

Advantageously, the disclosure described above achieves torque transmission with the use of screw segments in the area of extruders, i. e. single-screw extruders and twin-screw extruders, with the stresses on the spindle known from the state of the art, which can be very high and include torsion, traction, pressure and flection, being reduced. Therefore, the risk of mechanical failure of the spindle is substantially reduced as well. In addition, less expensive shafts, ideally smooth cylinders, can be used for the spindle, which in addition increases availability of the shafts.

The moment bridge can be of a different material than the segments.

For example, it is conceivable to design the moment bridges for a different load than the segments. Theoretically, the moment bridges are almost exclusively subjected to shearing stresses so that often materials with better mechanical properties can be used than for the edges of the extruder windings on the segments, which are subjected to many different types of stresses.

In addition, the moment bridge can be made of a different material than the spindle.

In this regard as well, the stresses to be expected can be better alleviated in constructing the screw. In case of an ideal construction, the spindle would substantially have to bear the axial tensile load created during bracing of the segments for sealing the segment boundaries. In addition, the spindle will normally have to bear the bending moment caused by the own weight of the segments and by its own weight as soon as the extruder direction deviates from the vertical. However, the effects of own weight can normally be regarded as minor problems in contrast with the bracing force.

If the moment bridge is arranged radially outside the spindle, the geometry of the spindle can be simple.

Ideally, the spindle will have a circular cross-section within the segments. The notch factor β will ideally be 1. The more circular and smooth the cross-section of the spindle, the larger will the portion of the torque be which is transferred from segment to neighboring segment via the moment bridge, and thus laterally to the spindle, due to positive engagement.

This supports desired separation of the mechanical stresses, in which it is the task of the screw segments themselves to transfer the torsion stress via the moment bridges.

The moment bridge has—also preferably—a circular recess facing the spindle so that between the moment bridge and the spindle as well, the created catch effect is as little as possible and thus moment transfer is also as little as possible.

The moment bridge has to engage in at least two segments.

The two segments connected by the moment bridge are, in the simplest case in terms of construction, the segments axially directly adjacent to the screw. However, alternatives are also conceivable where a moment bridge transfers also or only the moment from a first segment to a third or even farther away segment, e. g. by means of recesses through a segment for one moment bridge each or parts of a moment bridge.

In terms of construction, it is proposed for the moment bridge to have the shape of a sleeve, with an axial extension and a radial material thickness, where the axial extension is larger than the radial material thickness many times over.

In particular, proportions are considered where the axial extension is at least five times, preferably ten times, larger than the radial material thickness, i. e. the simple thickness of the sleeve wall. Both the axial extension and the radial material thickness are here determined as the arithmetic average over the circumference.

A sleeve can easily be slid onto a cylindrical spindle and can also be easily slid into a first segment, or a second segment can easily be slid over it, respectively; so that between the first segment and the moment bridge, and the moment bridge and the second segment, one positive engagement each is created, at the latest in case of a twist.

To keep the spirals in as fixed a position as possible, the segments should preferably be tangentially fixed by the moment bridge.

To create positive engagement between the moment bridge and the segments, it is conceivable both for the moment bridge to have axial teeth and for it to have radial teeth.

To avoid axial pressing of the moment bridge and achieve as complete a separation of the various mechanical stresses as possible, it is conceivable for the moment bridge to have axial play between the segments.

For instance, a feather key can be inserted which in the torsional direction acts as a carrier between the moment bridge and a segment which has been slid on; the axial play ensuring that the entire axial prestress affects exclusively the gaps between the segments, but not the feather keys or the other carriers.

Preferably, the moment bridge has a close axial sliding fit with respect to the spindle, just like the segments preferably have a close axial sliding fit with respect to the spindle and/or the segments have a close axial sliding fit with respect to the moment bridge. Tangentially, the moment bridge should be fixed in relation to the spindle, i. e. it should not only have a close sliding fit; in any case, however, the moment bridge should be fixed in relation to the segments without slippage.

A “close sliding fit” is a fit defining a fixed seat, where however the parts are not keyed in with each other. An explanation concerning “close sliding fit” can be found e. g. in Lueger, Otto: “Lexikon der gesamten Technik and ihrer Hilfswissenschaften, Band 7” Stuttgart, Leipzig 1909, page 47.

The “spindle” is to be understood to axially extend in any case from the end of the first segment to the beginning of the last segment. Introduction of the moment into the screw is possible both via the spindle—in this case, tangential fixation between the gear power take-off and the spindle is necessary—and via a connection of the gear power take-off with at least one segment, preferably the first segment in the axial direction, with the connection transferring the moment.

To facilitate assembly, the moment bridge can be attached to a segment so that it can be released in a nondestructive manner. For instance, it is conceivable for the moment bridge to be attached in a press fit or close sliding fit to the interior of a segment. When the screw is assembled, the segment simply needs to be threaded onto the spindle together with the moment bridge which has already been attached. If several such segments which all have an attached moment bridge on the same side are threaded on in series, the screw is assembled automatically.

Alternatively, the moment bridge can be separate from the two segments which it connects.

In any case, the disclosure is to be regarded as implemented when the segments, the spindle and the moment bridge are coordinated such that at least 70% of a moment, in particular at least 80%, are transferred from segment(s) to segment(s) via (a) moment bridge(s); thus, maximally 30% are transmitted via the spindle, in particular maximally 20%.

In prototype tests conducted by the inventors and in their model calculations, however, substantially lower transmission rates for the spindle have been found.

In particular, if the segments are freely rotatable around the spindle, it is ensured simply by this fact that moments are transmitted from them to the spindle only due to friction and own weight.

It is clear that the advantages of a screw as described above extend directly to an extruder, in particular a one-screw extruder or a twin-screw extruder having a screw as described above.

### BRIEF DESCRIPTION OF THE DRAWINGS

In the following, the disclosure will be described in more detail by means of different embodiments with reference to the drawings wherein:

FIG. 1 shows a simplifed longitudinal section of a first embodiment of a screw with segments and moment bridges having the form of catch plates on a spindle,

FIG. 2 shows the screw from FIG. 1 along the line II-II,

FIG. 3 shows a second embodiment of a screw according to the disclosure in a representation analogous to FIG. 1,

FIG. 4 shows the screw from FIG. 3 in cross-section along the line IV-IV,

FIG. 5 shows a top view of a coupling ring shown in FIGS. 3 and 4 within the screw,

FIG. 6 shows, in a third embodiment of the disclosure, a screw having a sleeve with external toothing as a moment bridge,

FIG. 7 shows the screw from FIG. 6 in a cross-section along line VII-VII,

FIG. 8 shows, in a fourth embodiment of the disclosure, a screw having a fork-shaped sleeve as the moment bridge,

FIG. 9 shows the fork-shaped sleeve from FIG. 8 alone,

FIG. 10 shows, in a fifth embodiment of the disclosure, a screw having a toothed ring with curved teeth as the moment bridge,

FIG. 11 shows a schematic longitudinal section of a sixth embodiment of a screw according to the disclosure, having continuous bars as the moment bridge,

FIG. 12 shows the screw from FIG. 11 in a schematic cross-section along line XII-XII in FIG. 11, and

FIG. 13 schematically shows a perspective view of a bar as used in FIGS. 11 and 12.

### DETAILED DESCRIPTION OF THE DRAWINGS

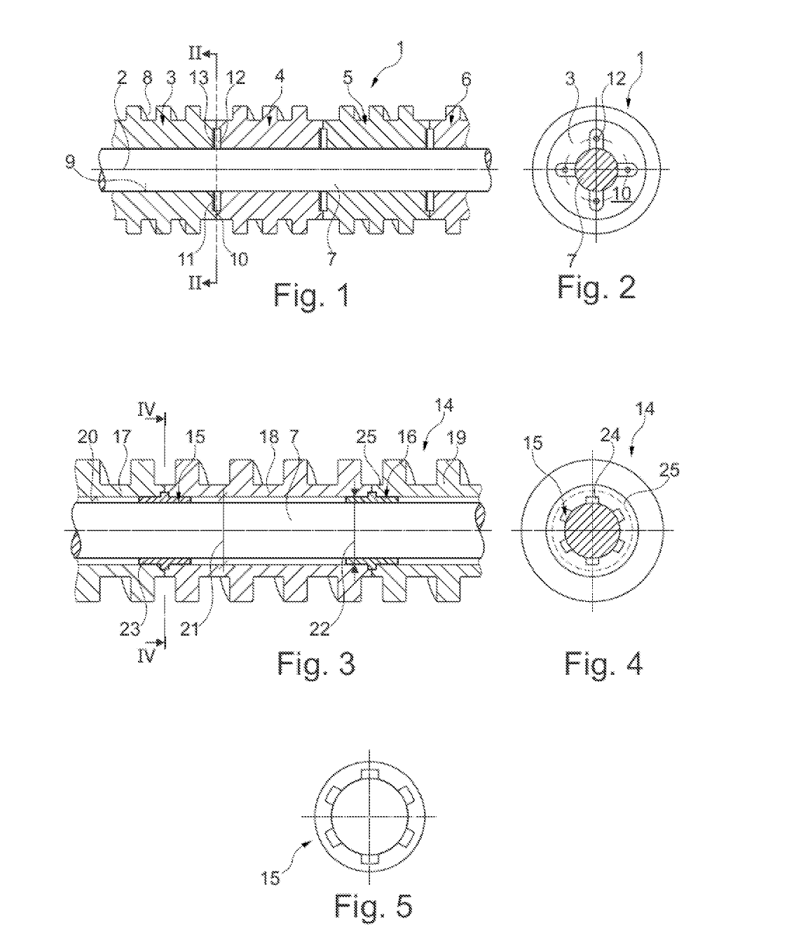

The screw 1 in FIGS. 1 and 2, in the section visible in the Figures, comprises screw segments axially adjacent and prestressed against each other along a longitudial extension 2, i. e. a first segment 3, a second segment 4, a third segment 5 and a fourth segment 6. The screw segments are threadingly pushed against each other onto the spindle 7 in the longitudinal extension 2.

Each screw segment has spirals 8 (numbered by way of example) radially on the outside and an interior cylinder radially on the inside, e. g. the first segment 3 over a first interior cylinder 9.

In addition, at an axial end face 10, the screw segments each have exactly four disk-shaped recesses 11 (numbered by way of example).

The disk-shaped recesses 11 of every two adjacent screw segments, e. g. the first segment 3 and the second segment 4, are flush, axially in front of each other and abut against each other. They contain four finger-shaped disks 12 (numbered by way of example). The finger-shaped disks 12 have an axial extension which clearly exceeds an axial depth of the disk-shaped recesses 11, but by less than 100%. In this manner, the axial end faces 10 of every two neighboring screw segments securely rest against each other under prestress, thus sealing the resultant screw 1 against plastic material flows from the outside to the interior towards the spindle 7; at the same time, however, the finger-shaped disks 12 are guided in recesses each of which has an axial dimension of two disk-shaped recesses 11. They are positioned there with an axial play 13 which is less than the axial depth of the disk-shaped recesses 11 and less than an axial extension of the finger-shaped disks 12.

Tangentially, the finger-shaped disks 12 rest inside the disk-shaped recesses 11 in a close sliding fit so that tangentially there is no play between the segments and the finger-shaped disks 12, e. g. so that in a rotational movement, the first segment 3 positively engages with the finger-shaped disks 12 and the finger-shaped disks 12 positively engage with the second segment 4, causing a rotational movement of the first segment 3 to be transferred without play to the axially adjacent second segment 4.

During operation of the screw 1, the four finger-shaped disks 12 between the first segment 3 and the second segment 4 serve as the moment bridge.

The moment bridge is the new constructive element proposed here which is connected to at least two screw segments and whose task it is to transmit the torque of one segment to the next. Therefore, the torque is no longer transmitted via the spindle 7, as in the state of the art. The spindle 7 remains free of the torque stress; in the science concerning strength of materials, one would speak of a separation between torsional stress and direct stress. Thus, the novel screw spindle has a smaller diameter and can be completely smooth on the outside. This increases permissible stresses in the area of the spindle 7. Also, the basic material of the new constructive element, i.e. of the moment bridge, can differ from that of the spindle. Thus, the respective material can be better adapted to the tasks to be solved: the material of the new constructive element (i.e. the moment bridge), can be mainly adapted for shearing forces; the spindle material, in contrast, for flexural-type stresses and axial forces.

One of the finger-shaped disks 12 could already serve as a catch. However, use of a plurality of separate parts, in the present case four finger-shaped disks 12, as a catch between two axially adjacent segments and thus as a moment bridge in the sense of the present patent application, leads to a load distribution and to a screw whose own weight has its center of gravity in the longitudinal axis. When the screw rotates, no eccentric centrifugal forces and no eccentric weight loads will occur.

With reference to FIGS. 3 and 4, in the second embodiment of the disclosure for an axially segmented screw 14, a first coupling ring 15 (see specifically also FIGS. 4 and 5) and a second coupling ring 16 are used as moment bridges. Each coupling ring 15, 16 is cylindrical on the inside and therefore glides on the spindle 7 without any substantial transmission of torque (functionally equivalent or identical elements are sometimes designated by the same reference numbers throughout the figures). Therefore, here as well, the spindle 7 can be largely free from the transmission of torques even during operation of the screw 14, and merely subjected to tensile forces, which it absorbs due to the fact that the screw segments are pressed together axially for sealing and fixing the spirals.

The screw segments, here e. g. a first segment 17, a second segment 18 and a third segment 19, are also formed cylindrical towards their interior 20, however with an interior diameter 21 corresponding to an exterior diameter 22 of the coupling rings 15, 16 in their sleeve-like portions on both sides. Therefore, the segments 17, 18, 19 of the screw 14 can be slid onto the sleeve-shaped portions 23 (indicated by way of example), preferably in a close sliding fit. The moment between the coupling rings 15, 16 and the segments 17, 18, 19 is transferred by means of radial protrusions 24 which engage in corresponding radial recesses 25 (numbered by way of example) in the segments 17, 18, 19.

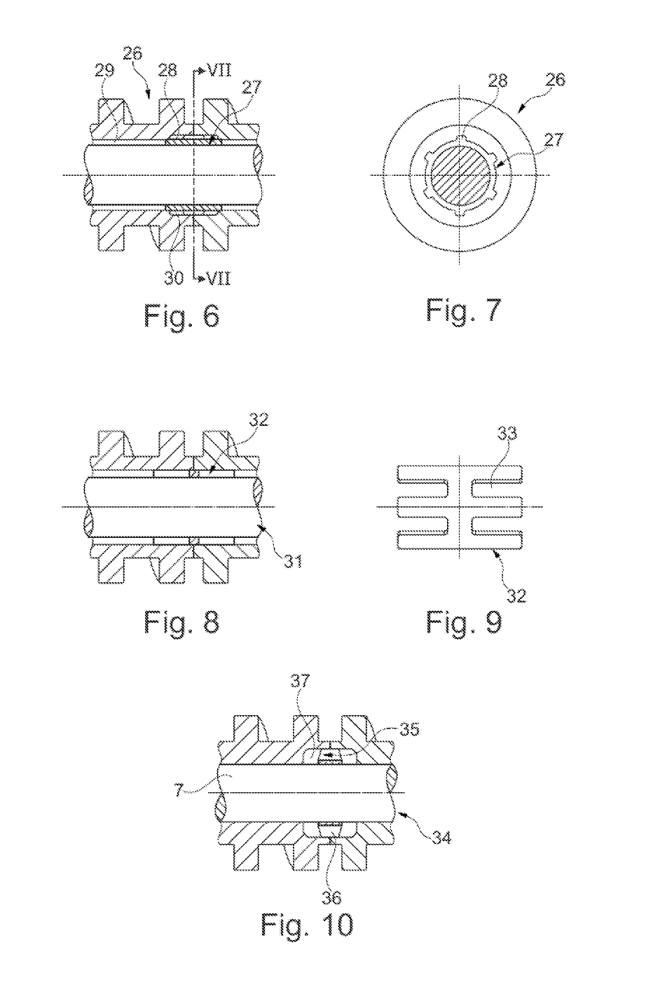

For creating a moment bridge, various other embodiments are possible as well, e. g. the third embodiment of a screw 26 in FIGS. 6 and 7, which uses a sleeve 27 with outer teeth 28, which also uses a ring-shaped slot 29 between the segments and the spindle, but is furthermore provided with a second ring-shaped slot 30 for leaving an axial play between the outer teeth 28 and the material edges in the segments and thus for preventing direct forces from affecting the outer teeth 28.

In the fourth embodiment of a screw 31, shown in FIG. 8, a fork-shaped sleeve 32 (see FIGS. 8 and 9) is used as the moment bridge. The fork-shaped sleeve 32 substantially corresponds to two hubs which are mutually attached at their backs and have continuous and cleared grooves 33 (numbered by way of example), but which are preferably integral so that feather keys formed on or attached to the segments can be slid into the grooves 33 and so that here again, there is preferably no tangential play, creating an immediate catch for torsional forces, whereas a play should remain in the axial direction.

In the fifth embodiment of a screw 34 (see FIG. 10), an annular gear 35 is provided as the moment bridge which has a plurality of curved teeth 36 (numbered by way of example) and can be slid on the spindle 7 in the longitudinal direction, with an open ring-shaped slot 37, here again, existing between the segments which are axially pressed onto each other, the longitudinal axial extension of the ring-shaped slot being larger than the longitudinal axial extension of the annular gear 35 so that no axial forces are applied to the curved teeth 36 by the segments, but so that a tangential engagement, without play, if possible, is created between the curved teeth 36 and the neighboring segments.

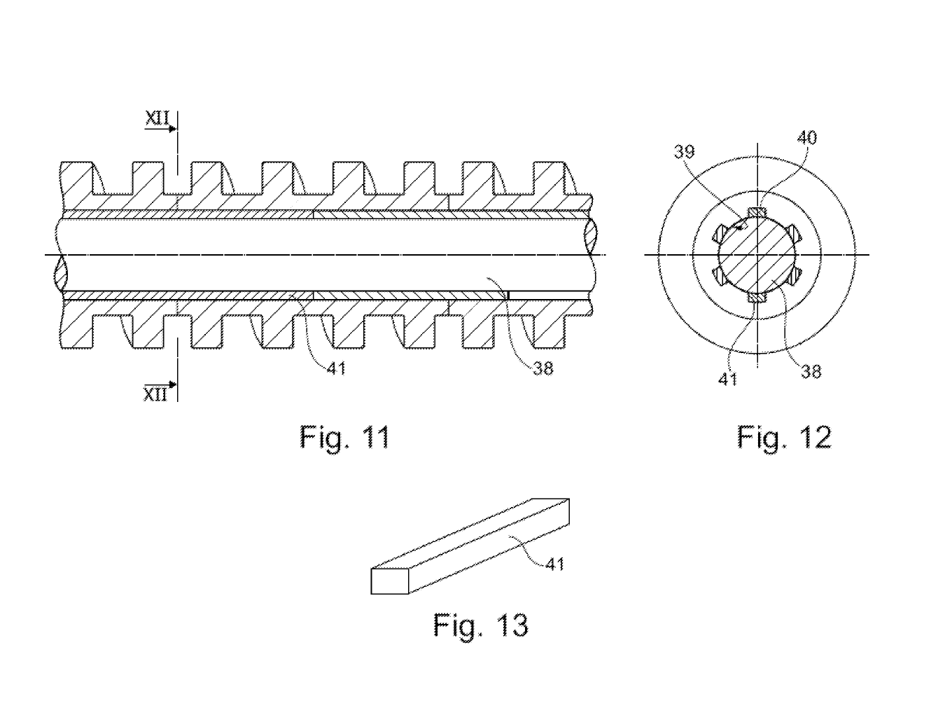

The screw in the sixth embodiment of the disclosure (FIGS. 11 and 12) again has a plurality of segments (three segments are shown in FIG. 11) which are arranged on a spindle 38. The spindle 38 has a circular cross-section on the outer circumference of which a circular inner circumference 39 of the segments fits in close sliding fit.

On their inner circumference 39, the segments have evenly spaced driving slots 40 (numbered by way of example) with a rectangular cross-section.

The driving slots 40 of the segments are arranged flush with each other. Through the flush driving slots 40, driving bars 41 (numbered by way of example, see also FIG. 13) are inserted. Respective bars can be axially divided, or they can extend over the entire segment length. The driving bars 41 are made of a material with high shearing strength, such as spring steel, so as to be perfectly suited for the almost exclusive shear stresses.

Generally, as a possible embodiment, the possibility of using several feather keys should be mentioned which are distributed over the circumference and can additionally be connected by a ring. The feather keys can also have different axial lengths and/or be arranged mutually axially offset. Another embodiment provides for several bushings which are slid onto the spindle. On the outside of the bushings, grooves can be provided, for example, which connect at least two segments by means of additional feather keys. However, the bushings can also have springs, which would make additional feather keys unnecessary. Here as well, at least two segments are interconnected.

In all conceivable embodiments, the springs or grooves can either be narrow or alternatively have a large width. The advantage of large widths is that the number can be limited to a few and that the function of torsion transfer is ensured.

Preferably, therefore, in an embodiment of the present disclosure, a maximum of ten, preferably a maximum of eight, six, four or two driving edges from a segment to the moment bridge and preferably an identical number from the moment bridge to the next neighboring segment are provided.

Briefly speaking, the disclosure is implemented if an additional constructive element is provided between segment and spindle, which element engages at least two segments, with the segments radially overlapping the additional constructive element and with at least 70%, in particular at least 80% or 90%, of the torque being transferred from segment(s) to segment(s) via the additional constructive element(s), i. e. at the most 30%, in particular at the most 20% or 10%, are transferred via the spindle.

In general, it should be pointed out that the moment is most easily applied to the screw at the segment which is located first as seen from the gear power take-off. It is there that the moment to be applied is largest because the largest percentage by mass of the material to be conveyed is present in the form of granules. The further the material proceeds through the extruder, the larger the portion of molten granulate becomes which leads to a reduction in resistance of the material against screw rotation, and thus also to a reduction of the moment which needs to be carried off.

1. A worm screw for use in an extruder, where the screw has a spindle and a plurality of segments supported by the spindle and mutually arranged axially, with sealed segment boundaries, wherein between a first segment and an axially adjacent second segment, a separate moment bridge is provided which is configured to transfer a moment over the segment boundary from the first segment to the second segment besides of the spindle.

2. The worm screw for use in an extruder according to claim 1, wherein the segments form a spiral radially on the outside, the screw having, in axial arrangement, a first segment and subsequently additional segments down to a last segment, with the spindle extending from the first to the last segment
wherein the spindle, in opposition to a segment, has a circular cross-section.

3. Worm screw according to claim 1, wherein the moment bridge is made of a different material than the segments.

4. Worm screw according to claim 1, wherein the moment bridge is made of a different material than the spindle.

5. Worm screw according to claim 1, wherein the moment bridge is arranged radially outside the spindle.

6. Worm screw according to claim 1, wherein the moment bridge is arranged radially within the segments.

7. Worm screw according to claim 1, wherein the spindle has a circular cross-section within the segments.

8. Worm screw according to claim 1, wherein the segments have a circular recess facing the spindle, and have a driving engagement notch deviating from a circular recess, which faces the moment bridge.

9. Worm screw according to claim 8, wherein the moment bridge has the form of a bar and passes through a plurality of segments, with the bar passing at several segments, through one driving slot each free of tangential play.

10. Worm screw according to claim 9, wherein the bar rests on the spindle along its length, with the driving engagement notches of the segments being open towards the spindle.

11. Worm screw according to claim 1, wherein the moment bridge has a circular recess facing the spindle.

12. Worm screw according to claim 1, wherein the spindle is circular in cross-section over its entire longitudinal extension axially within the segments.

13. Worm screw according to claim 1, wherein the moment bridge engages in two or more segments.

14. Worm screw according to claim 1, wherein the moment bridge has the form of a sleeve, with an axial extension and a radial material thickness, with the axial extension being larger than the radial material thickness multiple times over.

15. Worm screw according to claim 1, wherein the moment bridge has an axial toothing.

16. Worm screw according to claim 1, wherein the moment bridge has a radially arranged and, thus tangentially acting toothing.

17. Worm screw according to claim 1, wherein the moment bridge has an axial play between the segments.

18. Worm screw according to claim 1, wherein the moment bridge has a close sliding fit with respect to the spindle.

19. Worm screw according to claim 1, wherein the segments have a close sliding fit with respect to the spindle.

20. Worm screw according to claim 1, wherein the segments have a close sliding fit with respect to the moment bridge.

21. Worm screw according to claim 1, wherein the moment bridge is attached to a segment such that it can be released in a nondestructive manner.

22. Worm screw according to one of claim 1, wherein the moment bridge is separate from the two segments.

23. Worm screw according to claim 1, wherein the segments, the spindle, and the moment bridge are configured to transfer at least 70% of a moment from a first segment to a second segment via the moment bridge.

24. Worm screw according to claim 1, wherein at least one segment is configured to be freely rotatable about the spindle.

25. Extruder with a worm screw according to claim 1.
